(19) United States
(12) Patent Application Publication
(10) Pub. No.: US 2025/0330106 A1
(43) Pub. Date: Oct. 23, 2025

(54) MOTOR CONTROL CIRCUIT AND METHOD FOR MONITORING AT LEAST ONE DC LINK CAPACITOR OF THE MOTOR CONTROL CIRCUIT

(71) Applicant: ebm-papst Mulfingen GmbH & Co. KG, Mulfingen (DE)

(72) Inventors: Sebastian SCHROTH, Mulfingen (DE); Marius GREISS, Wuerzburg (DE)

(21) Appl. No.: 19/184,660

(22) Filed: Apr. 21, 2025

(30) Foreign Application Priority Data
Apr. 22, 2024 (DE) 102024111256.5

(51) Int. Cl. H02P 21/14; H02P 21/22

(52) U.S. Cl. CPC H02P 21/14; H02P 21/22

(57) ABSTRACT

The present disclosure relates to a motor control circuit and to a method for monitoring at least one DC link capacitor in an electrical DC link of a motor control circuit of an electrically commutated (EC) motor with motor windings, which is operated on a voltage source, in which rectifier diodes of the rectifier close as intended in order to prevent energy consumption from the voltage source for a defined period of time, wherein a DC link capacitance (C_{ZK}) of the DC link capacitor is determined, and a remaining service life or an end of service life and/or useful life of the DC link capacitor is determined from the determined DC link capacitance (C_{ZK}) by means of an evaluation circuit.

### RELATED APPLICATIONS

This application claims priority to German Patent Application No. 10 2024 111 256.5, filed Apr. 22, 2024, the entire contents of which is incorporated herein by reference in its entirety.

### FIELD

The present disclosure relates to a motor control circuit and to a method for monitoring at least one DC link capacitor in an electrical DC link of a motor control circuit of an electrically commutated motor with motor windings, the motor control circuit being operated on a voltage source.

### BACKGROUND

The present disclosure relates to a motor control circuit and to a method for monitoring at least one DC link capacitor in an electrical DC link of a motor control circuit of an electrically commutated motor with motor windings, the motor control circuit being operated on a voltage source.

A variety of methods for determining the instantaneous capacitance and/or the internal loss resistance as an aging indicator for one or more DC link capacitors during operation of an electrically commutated motor are known from the prior art.

EP 0 652 445 A2 describes a method of charging and discharging the DC link capacitor using targeted switching operations of the inverter, enabling the DC link capacitance to be calculated using the measured voltage and current curves.

DE 10 2019 117 369 A describes a method for calculating the DC link capacitor current using the mains current and the motor current. The DC link voltage can be calculated using the calculated DC link current and applying the formula u_{dc}=1/C_{ZK}∫i_{dc}dt. The capacitance value C_{ZK} is formed from a comparison between the calculated and the measured DC link ripple of the voltage, with an integrator adjusting the capacitance until a comparison between the model and the measured DC link voltage has taken place.

CN105717368B describes a method for monitoring capacitance and equivalent series resistance (ESR) as an aging indicator for the DC link capacitor in a 3-phase inverter. The capacitor current is reconstructed using the formula: idc=Sa·ia+Sb·ib+Sc·ic with ia, ib, ic the motor phase currents and Sa, Sb, Sc the switching states of the inverter already being present in the motor controller. The voltage drop across the DC link capacitor at a specific point in time is also taken into account.

EP 3 477 314 B1 describes a method for real-time detection of the capacitance of the DC link capacitor, which is used for certain switching states of the inverter in which the current through the diode rectifier of the inverter is 0A in order to measure the DC link current and the DC link voltage using the sensors that are already present and then to determine the capacitance using an approximate formula.

Furthermore, EP 3 555 644 B1 describes a method for measuring the discharge curve in the DC link ripple of the voltage and for determining the capacitance and remaining service life of the capacitor with the aid of a digital evaluation.

### BRIEF SUMMARY

The present disclosure overcomes the aforementioned disadvantages and provides a motor control circuit and a method in which a determination of the instantaneous capacitance and/or the internal loss resistance as an aging indicator for one or more DC link capacitors is optimized during operation of an electrically commutated motor.

In the present disclosure the so-called field-oriented control may be used in controlling electric motors. The motor phase currents iₐ, i_{b}, i_{c} are converted from the stator-fixed coordinate system into a rotating rotor-fixed coordinate system into the components i_{d}, i_{q}. In general, the q-component of the current is used to control the speed. The deviation between the target and actual speed is minimized, for example, using a proportional-integral controller (PI controller). A setpoint value for the q-current that generates the torque is calculated from the deviation so that, to put it simply, the controller changes the torque of the motor until the setpoint speed is reached. The d-current component, on the other hand, does not contribute to the generation of torque, but forms a magnetic field of the motor windings that does not influence the torque of the motor. In order to achieve high levels of efficiency in electric motors, the d-current is therefore usually set to a set value of 0A, controlled using a PI controller, for example. To achieve higher speeds, the d-current is often even adjusted to a negative setpoint in order to deliberately weaken the magnetic field of the electric motor (field-weakening operation). The coils of the electric motor therefore store energy in the magnetic field of their windings, which can be specifically influenced via the d-current component.

For electric motors operated on a 3-phase mains, usually only a small energy buffer in the form of a DC link capacitor, for example is required between the mains and the frequency converter to ensure stable motor operation. The DC link capacitor reduces the ripple of the DC link voltage, which is caused by the pulsed power consumption by a PWM converter, for example. The voltage ripple therefore generally depends on the amount of the capacitance of the DC link capacitor. However, in the case of 3-phase electric motors, this dependence is comparatively small, since the 3 mains voltages, which are phase-shifted by 120°, result in a more continuous power flow from the mains after rectification than would be the case, for example, if the motor were connected to only a single mains phase. Typically, a decrease in capacitance or an increase in internal loss resistance (ESR; equivalent series resistance) is used as an aging indicator to detect the aging of capacitors.

The present disclosure increases the DC link ripple of the voltage in a 3-phase electric motor for a short period of time by deliberately storing and discharging energy in the magnetic field of the motor windings and makes inferences about the aging of the DC link capacitor from the resulting DC link ripple of the voltage, which is usually detected at the devices anyway. These charging and discharging processes are achieved by specifically specifying the d-current component as a setpoint for the existing controller.

According to the disclosure, a method is therefore proposed for monitoring at least one DC link capacitor in an electrical DC link of a motor control circuit of an electrically commutated motor with motor windings, which motor control circuit is operated on a voltage source and/or mains voltage. The motor control circuit comprises a rectifier and an inverter, in particular a frequency converter. Furthermore, at least one DC link capacitor to be monitored is located between the rectifier and the inverter. The method involves detecting the motor phase currents and determining a d-current component for controlling and/or regulating the motor, in particular in pointer notation in the rotating or rotor-fixed coordinate system. Furthermore, a voltage ripple of a DC link voltage to be set at the DC link capacitor is detected and/or measured. In addition, the d-current component is controlled by means of a controller in such a way that energy from the voltage source and/or motor control circuit is stored in a magnetic field of the motor windings of the EC motor, and the d-current component is controlled by means of the controller in such a way that the energy stored from the voltage source and/or motor control circuit in the magnetic field of the motor windings of the EC motor is discharged back into the motor control circuit, in particular into the at least one DC link capacitor. Upon discharging of the stored energy from the magnetic field of the motor windings of the EC motor, the DC link voltage is greater than the input voltage of the voltage source, so that the rectifier diodes of the rectifier are blocked as intended in order to prevent energy from being drawn from the voltage source for a defined period of time. In addition, a DC link capacitance of the DC link capacitor is determined, and a remaining service life or an end of service life and/or useful life of the DC link capacitor is determined from the determined DC link capacitance by means of an evaluation circuit, which in particular has a microcontroller.

An advantage over the prior art is that the evaluation of the capacitance can be carried out during operation of the motor and only has a minor influence on motor operation. Furthermore, the decrease in DC link capacitance due to aging effects often takes place over a period of several weeks to months, so that the process cannot be carried out continuously but only at fixed maintenance intervals. In addition, the method does not require any additional hardware, but rather relies on the motor's existing sensors. Existing evaluation methods can be used to evaluate the current and voltage curves, since the motor current and the DC link voltage are detected by the motor controller anyway.

The energy stored in the motor windings

$$W = \frac{1}{2} L * {i}_{L}^{2}$$

can be converted into a corresponding output

$${P}_{Wicklung} = \frac{1}{2} L \cdot {i}_{L} \cdot \frac{{di}_{L}}{dt} ,$$

where L is the winding inductance and i_{L} the current through the winding.

In an advantageous embodiment, a provision is made that the d-current component for storing energy from the voltage source and/or motor control circuit in the magnetic field of the motor windings is controlled by the controller in Such a way that:

$${i}_{L} > 0 and \frac{{di}_{L}}{dt} > 0 ; or {i}_{L} < 0 and \frac{{di}_{L}}{dt} < 0 .$$

In one embodiment of the disclosure, a provision is made that the d-current component for storing energy from the motor control circuit in the motor windings is controlled by means of the controller in such a way that the storage takes place continuously over more than one mains period of the voltage source. Any influence on the operation of the EC motor is thus reduced.

Furthermore, one embodiment is advantageous in which the d-current component for discharging the energy stored in the magnetic field of the motor windings from the magnetic field of the motor windings back into the motor control circuit is controlled by the controller in such a way that:

$${i}_{L} > 0 and \frac{{di}_{L}}{dt} < 0 ; or {i}_{L} < 0 and \frac{{di}_{L}}{dt} > 0 .$$

Preferably, the d-current component id is regulated after the discharge by means of the controller 5 to a predetermined negative setpoint value or to the setpoint value 0 A.

In another advantageous variant, the disclosure makes a provision that the d-current component is controlled by means of the controller in such a way that it has a sawtooth-shaped curve and/or an at least partially sinusoidal curve and/or a rectangular step-shaped curve.

It is also advantageous if the motor control circuit has a sensor system for operating the EC motor and this sensor system is used simultaneously for power detection and/or voltage detection of the voltage ripple at the DC link capacitor and/or for at least intermittent determination of the motor phase currents during operation of the EC motor.

In an advantageous embodiment, a provision is made that the motor phase currents are determined at least intermittently during operation of the EC motor.

In a preferred embodiment, the power measurement and the voltage measurement at the DC link capacitor are carried out to determine the capacitance of the DC link capacitor in order to determine the DC link voltage.

In one design variant of the disclosure, a provision is made that the entire voltage curve and/or a filtered and/or correlated signal curve of the DC link voltage are used when determining the capacitance.

Furthermore, it is advantageous if the DC link capacitance is determined by an observer system. The DC link current is simulated from input measurands of the motor control circuit that have already been detected and are required to control the motor operation anyway, such as the power drawn from the mains, the power outputted by the motor, the mains input voltage, the motor current, and the phase voltages of the motor. The DC link current is then multiplied by the inverse DC link capacitance and integrated in order to calculate an estimated DC link voltage. The difference between the estimated DC link voltage and the actually measured DC link voltage is also integrated and then considered as the inverse DC link capacitance, resulting in an observer loop. This control loop adjusts the estimated DC link voltage to the measured DC link voltage and is thus able to estimate the DC link capacitance.

In addition, one variant is advantageous in which the observer is only activated while the voltage ripple of the DC link voltage is greater than the input voltage of the voltage source, after which it is deactivated. In particular, activation and/or deactivation are achieved by multiplying by 0 or, within a control algorithm, by not performing a calculation of the observer.

In another advantageous embodiment, a maximum value of the voltage ripple and/or a comparison between a detected voltage curve and a look-up table are used to infer a decrease in the DC link capacitance or an increase in an internal loss resistance of the DC link capacitor. In the context of the disclosure, a look-up table refers to a data structure that is used to efficiently retrieve the value of a function or other data set. It consists of a set of key-value pairs, with each key being assigned a corresponding value. When a specific key value is needed, the look-up table can be used to quickly retrieve the corresponding value instead of recalculating the function or the data.

In one preferred design variant of the disclosure, the controller is a PI controller. In particular, a setpoint for the d-current component is calculated using a superposed PI controller. In this case, a difference between the target DC link voltage and the measured DC link voltage is switched to an input of the controller, whereby in particular a step-like excitation is added to the measured DC link voltage as the target DC link voltage and/or a constant value is used, whereby a curve of the d-current component is formed by the controller.

In another advantageous embodiment, the disclosure makes a provision that, for the evaluation of the DC link capacitance, a stroke, which represents a characteristic, in particular a curve shape, of the DC link voltage, is stored for a predetermined and/or varying d-current component and power over time and/or over time intervals, in particular in the controller or a data memory or a control unit, and is evaluated, preferably by means of a neural network and/or an artificial intelligence stored in the controller or the data memory or the control unit.

In another advantageous variant, a provision is also made that the curve shape of the d-current component is adapted by means of a neural network and/or artificial intelligence and/or as a function of the motor power and/or the speed during operation depending on the operating point.

Furthermore, one embodiment is advantageous in which a spectrum of a predetermined target current is adapted by means of pre-filtering, preferably by means of a low-pass filter, in order to avoid noise generation of the motor windings, with parts of the spectrum and/or a required control reserve and/or a bandwidth being particularly reduced in a targeted manner.

Furthermore, in an advantageous embodiment of the disclosure, a temperature prediction of a temperature of the EC motor, preferably a winding temperature of the motor windings, is determined, in particular by means of a superposed neural network and/or a temperature model, in order to predict temperature jumps. The temperature jumps predicted in this manner are at least partially compensated for by regulating the d-current component by means of the controller, in particular by increasing the d-current component.

According to the disclosure, a motor control circuit of an electrically commutated motor with motor windings for monitoring at least one DC link capacitor in an electrical DC link of the motor control circuit of the EC motor operated on a voltage source is also proposed, preferably using a method according to the above disclosure. The motor control circuit comprises a rectifier and an inverter, in particular a frequency converter. At least one DC link capacitor to be monitored is located between the rectifier and the inverter. Furthermore, a controller is provided for controlling a d-current component of a DC link current such that energy from the motor control circuit is stored in a magnetic field of the motor windings of the EC motor and/or the energy from the motor control circuit correspondingly stored in the magnetic field of the motor windings is discharged back into the motor control circuit. In addition, an evaluation circuit is provided for the purpose of determining a remaining service life or an end of service life and/or useful life of the DC link capacitor from a determined DC link capacitance.

The features disclosed above can be combined as required, provided this is technically possible and they do not contradict one another.

### BRIEF DESCRIPTION OF THE DRAWINGS

Other advantageous refinements of the disclosure are characterized in the subclaims and/or depicted in greater detail below together with the description of the preferred embodiment of the disclosure with reference to the figures. Brief description of the drawings:

FIG. 1 shows a schematic circuit diagram of a motor control circuit;

FIG. 2 shows a time course of motor phase currents as well as of a q-current component and of a d-current component of the motor control circuit in the rotating coordinate system;

FIG. 3 shows a time course of rectified input voltages and of a DC link voltage as well as of a d-current component and of a motor current of the motor control circuit;

FIG. 4 shows a temperature progression of an inverter of the motor control circuit.

The figures are schematic examples. Same reference symbols in the figures indicate same functional and/or structural features.

### DETAILED DESCRIPTION

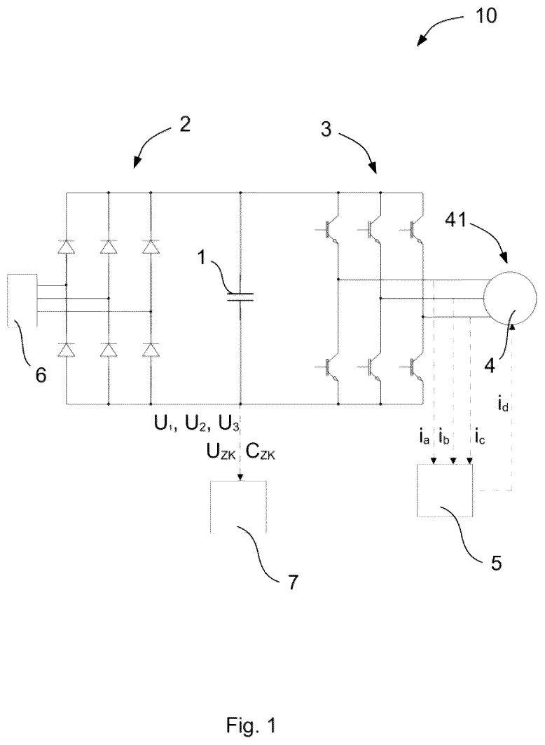

FIG. 1 shows a schematic circuit diagram of a motor control circuit 10 of an electrically commutated motor 4 with motor windings 41 for monitoring at least one DC link capacitor 1 in an electrical DC link of the motor control circuit 10 of the EC motor 4 operated on a voltage source 6. The motor control unit 10 comprises a rectifier 2 and an inverter 3. Furthermore, the DC link capacitor 1 to be monitored is located between the rectifier 2 and the inverter 3. In addition, a PI controller 5 is provided for controlling a d-current component id of a DC link current such that energy from the motor control circuit 10 is stored in a magnetic field of the motor windings 41 of the EC motor 4 and/or the energy from the motor control circuit 10 correspondingly stored in the magnetic field of the motor windings 41 is discharged back into the motor control circuit 10. In addition, an evaluation circuit 7 is provided for the purpose of determining a remaining service life or an end of service life and/or useful life of the DC link capacitor 1 from a determined DC link capacitance C_{ZK}.

The motor control circuit 10 has a sensor system for operating the EC motor 4, and this sensor system is used simultaneously for power detection and/or voltage detection of the voltage ripple at the DC link capacitor 1 and/or for at least intermittent determination of the motor phase currents iₐ, i_{b}, i_{c} during operation of the EC motor 4.

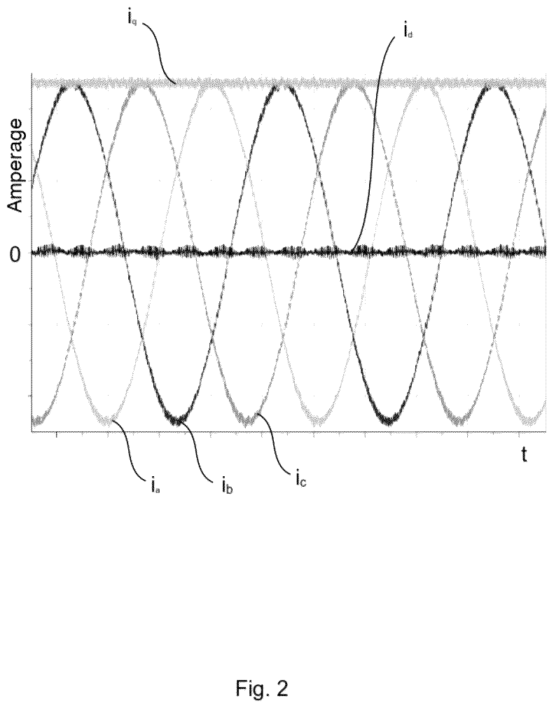

FIG. 2 shows a time course of motor phase currents iₐ, i_{b}, i_{c} as well as of a q-current component i_{q} and of a d-current component i_{d} of the motor control circuit 10 in the rotating coordinate system.

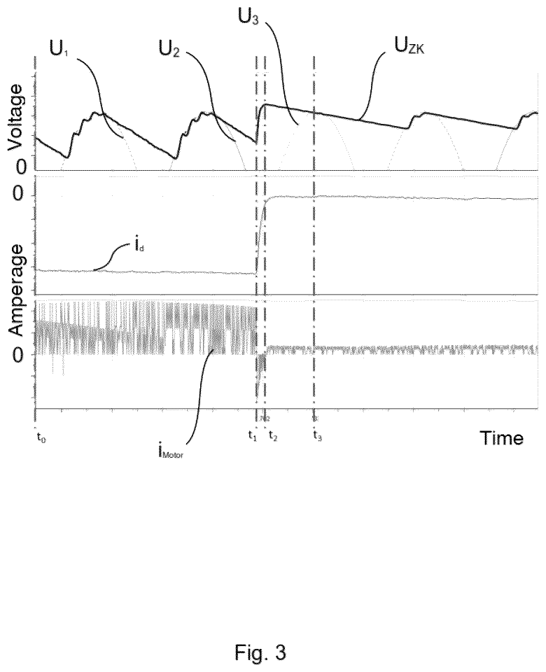

FIG. 3 shows a time course of rectified input voltages U₁, U₂, U₃ and of a DC link voltage U_{ZK} as well as of a d-current component i_{d} and of a motor current i_{Motor} of the motor control circuit 10 during application of a method according to the disclosure.

Since the voltage ripple of the DC link voltage U_{ZK} is to be increased briefly during regular motor operation, the energy stored in the magnetic field of the motor windings 41 must be sufficient for the continued operation of the motor and for feedback to the DC link capacitor 1, so that no current is drawn from the voltage source 6 in the meantime. For this purpose, the d-current component i_{d} is controlled by the controller 5 in such a way that it has a sawtooth-shaped curve.

This shows that, during the period t₀ through t₁, energy is stored in the magnetic field of the motor windings 41, since

$${i}_{d} < 0 and \frac{{di}_{d}}{dt} < 0.$$

In order to keep the influence on motor operation as low as possible, the steepness of the edge during this period is selected such that this charging takes place continuously over more than one mains period. In the following period, from t₁ to t₂, the d-current component i_{d} is increased with the steepest possible edge, so that

$${i}_{d} < 0 and \frac{{di}_{d}}{dt} < 0$$

and energy from the motor windings 41 is fed back into the DC link. The d-current component i_{d} is controlled by the controller 5 to a predetermined negative setpoint.

In order to control the d-current component i_{d} and q-current component i_{q}, it is necessary to measure the motor phase currents during operation. Since during feedback the voltage at the DC link capacitor U_{ZK} is greater than the voltage of the previously feeding input voltages U₁, U₂, U₃, the diodes of the rectifier 2 block and, for a short time, no energy is drawn from the voltage source 6, see period t₁ through t₃. Thus, both the current and the voltage curve of the DC link capacitor 1 are known, and the inverse capacitance value can be determined via the evaluation circuit 7 with the aid of an observer system.

In the method according to the disclosure, the motor phase currents iₐ, i_{b}, i_{c} are detected, and a d-current component i_{d} is determined for controlling and/or regulating the motor 4 in pointer notation in the rotating coordinate system. Furthermore, a voltage ripple of a DC link voltage U_{ZK} k to be set at the DC link capacitor 1 is detected and/or measured. In addition, the d-current component i_{d} is controlled by means of the controller 5 in such a way that energy from the motor control circuit 10 is stored in the magnetic field of the motor windings 41 of the EC motor 4, and the d-current component i_{d} is controlled by means of the controller 5 in such a way that the energy stored in the motor windings is discharged back into the motor control circuit 10. Upon discharging of the stored energy from the magnetic field of the motor windings 41 of the EC motor 4, the voltage ripple of the DC link voltage U_{ZK} is greater than the input voltage U₁, U₂, U₃ of the voltage source 6, so that rectifier diodes of the rectifier 2 close as intended in order to prevent energy from being drawn from the voltage source 6 for a defined period of time. In addition, the DC link capacitance C_{ZK} of the DC link capacitor 1 is determined, and a remaining service life or an end of service life and/or useful life of the DC link capacitor 1 is determined from the determined DC link capacitance C_{ZK} by means of an evaluation circuit 7.

In the method, the d-current component i_{d} for storing energy from the motor control circuit 10 in the magnetic field of the motor windings 41 is controlled by the controller 5 in such a way that:

$${i}_{L} > 0 and \frac{{di}_{L}}{dt} > 0 ; or {i}_{L} < 0 and \frac{{di}_{L}}{dt} < 0.$$

The d-current component i_{d} for storing energy from the motor control circuit 10 in the motor windings 41 is controlled by the controller 5 in such a way that the storage takes place continuously over more than one mains period of the voltage source 6. In addition, the d-current component i_{d} for discharging the energy stored in the magnetic field of the motor windings 41 from the magnetic field of the motor windings 41 back into the motor control circuit 10 is controlled by the controller 5 in such a way that:

$${i}_{L} > 0 and \frac{{di}_{L}}{dt} < 0 ; or {i}_{L} < 0 and \frac{{di}_{L}}{dt} > 0 .$$

The motor phase currents iₐ, i_{b}, i_{c} are determined at least intermittently by means of the sensors during operation of the EC motor 4. Furthermore, in order to determine the DC link capacitance C_{ZK} of the DC link capacitor 1, the power is measured, and the voltage is measured at the DC link capacitor 1 to determine the voltage ripple.

In the observer system for determining the DC link capacitance C_{ZK}, the DC link current is simulated from input measurands of the motor control circuit that have already been detected and are required to control the motor operation anyway, such as the power drawn from the mains, the power outputted by the motor, the mains input voltage, the motor current, and the phase voltages of the motor. The DC link current is then multiplied by the inverse DC link capacitance and integrated in order to calculate an estimated DC link voltage. The difference between the estimated DC link voltage and the actually measured DC link voltage is also integrated and then considered as the inverse DC link capacitance, resulting in an observer loop. This control loop adjusts the estimated DC link voltage to the measured DC link voltage and is thus able to estimate the DC link capacitance.

However, the observer is only activated while the voltage ripple of the DC link voltage U_{ZK} is greater than the input voltage U₁, U₂, U₃ of the voltage source 6. This is followed by deactivation, with activation and/or deactivation being achieved in particular by multiplying by 0 or, within a control algorithm, by not executing a calculation of the observer.

Alternatively, a maximum value of the voltage ripple and/or a comparison between a detected voltage curve and a look-up table are used to infer a decrease in the DC link capacitance C_{ZK} or an increase in an internal loss resistance of the DC link capacitor.

Moreover, it is possible to calculate a setpoint for the d-current component i_{d} using a superposed PI controller. A difference between the target DC link voltage and the measured DC link voltage U_{ZK} k is switched to an input of the controller 5. Furthermore, a step-like excitation is added to the measured DC link voltage U_{ZK} as the target DC link voltage, and/or a constant value is used, so that a curve of the d-current component i_{d} is formed by the controller 5.

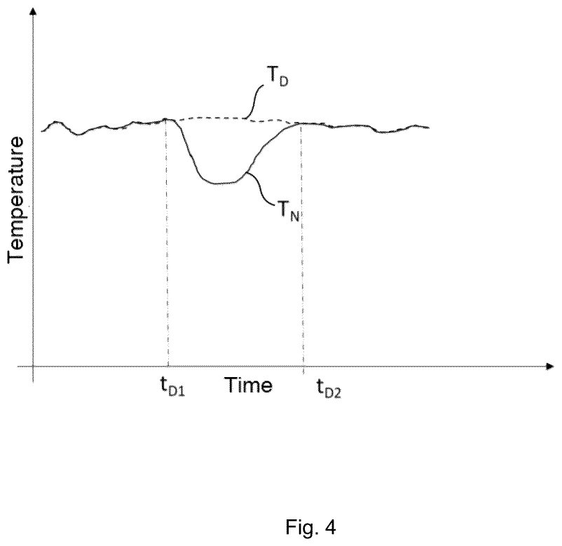

FIG. 4 shows a temperature progression of the inverter 3, in particular a power module of the inverter 3, of the motor control circuit 10.

Since the short-term increase in the magnitude of the d-current component i_{d} causes more power to be introduced into the EC motor 4 by the inverter 3, the temperature of the module is briefly increased by the method according to the disclosure. In another variant, the time of injection of the d-current component i_{d} is therefore deliberately chosen such that the aging of the inverter 3 can be reduced. Since the inverters 3, in particular the power modules thereof, usually age with an increasing number of temperature cycles or jumps, a temperature prediction of a superposed neural network or a temperature model, as shown in FIG. 4, can be used to predict temperature jumps, as shown between the times t_{D1} and t_{D2}. If a greater d-current component i_{d} is then set by the controller 5 between the times t_{D1} and t_{D2}, the inverter 3 passes through the temperature curve TD instead of the temperature curve TN. The number of temperature cycles during operation of the inverter 3 is thus reduced, and the service life is increased. It is also conceivable for the amount and the time course of the d-current component i_{d} to be selected such that inverter 3 specifically passes through a certain temperature progression without influencing the motor operation.

Accordingly, in one embodiment of the method, a temperature prediction of a temperature of the inverter 3 is determined, in particular by means of a superposed neural network and/or a temperature model, in order to predict temperature jumps, the temperature jumps predicted in this manner being at least partially compensated for by controlling the d-current component id by means of the controller 5, in particular an increase of the d-current component i_{d}.

The present disclosure is not limited in its execution to the abovementioned preferred exemplary embodiments. Rather, a number of variants are conceivable which make use of the illustrated solution even in the form of fundamentally different embodiments.

The invention claimed is:

1. A method for monitoring at least one DC link capacitor in an electrical DC link of a motor control circuit of an electrically commutated motor with motor windings operated on a voltage source, having a rectifier and an inverter, wherein the at least one DC link capacitor to be monitored is located between the rectifier and the inverter, comprising the steps:
a. detecting the motor phase currents (iₐ, i_{b}, i_{c}) and determining a d-current component (i_{d}) for controlling and/or regulating the motor;
b. detecting and/or measuring a voltage ripple of a DC link voltage (U_{ZK}) to be set at the DC link capacitor;
c. regulating the d-current component (i_{d}) by means of a controller (5) such that energy from the voltage source and/or motor control circuit is stored in a magnetic field of the motor windings of the EC motor;
d. regulating the d-current component (i_{d}) by means of the controller such that the energy stored in step c) is discharged back into the motor control circuit and the at least one DC link capacitor;
wherein, upon discharging of the stored energy from the magnetic field of the motor windings of the EC motor, the DC link voltage (U_{ZK}) is greater than an input voltage (U₁, U₂, U₃) of the voltage source, so that rectifier diodes of the rectifier block as intended in order to prevent energy from being drawn from the voltage source for a defined period of time,
e. determining a DC link capacitance (C_{ZK}) of the DC link capacitor;
f. determining a remaining service life or an end of service life and/or useful life of the DC link capacitor from the determined DC link capacitance (C_{ZK}) by way of an evaluation circuit,
wherein the d-current component (i_{d}) for storing energy from the voltage source and/or motor control circuit in the magnetic field of the motor windings is controlled by way of the controller in such a way that:
$${i}_{L} > 0 and \frac{{di}_{L}}{dt} < 0 ; or {i}_{L} < 0 and \frac{{di}_{L}}{dt} > 0 .$$

2. The method according to claim 1, wherein the d-current component (i_{d}) for storing energy from the motor control circuit in the motor windings is controlled by way of the controller in such a way that the storage takes place continuously over more than one mains period of the voltage source.

3. The method according to claim 1, wherein the d-current component (i_{d}) for discharging the energy stored in step c) in the magnetic field of the motor windings from the magnetic field of the motor windings back into the motor control circuit is controlled by way of the controller in such a way that:
$${i}_{L} > 0 and \frac{{di}_{L}}{dt} < 0 ; or {i}_{L} < 0 and \frac{{di}_{L}}{dt} > 0 .$$

4. The method according to claim 3, wherein the d-current component (i_{d}) is regulated after the discharge by means of the controller to a predetermined negative setpoint value or to the setpoint value 0 A.

5. The method according to claim 1, wherein the d-current component (i_{d}) is controlled by way of the controller in such a way that it has a sawtooth-shaped curve and/or an at least partially sinusoidal curve and/or a rectangular step-shaped curve.

6. The method according to claim 1, wherein the motor control circuit has a sensor system for operating the EC motor and this sensor system is used simultaneously for power detection and/or voltage detection of the voltage ripple at the DC link capacitor and/or for at least intermittently determining the motor phase currents (iₐ, i_{=b}p, i_{c}) during operation of the EC motor, wherein the motor phase currents (iₐ, i_{b}, i_{c}) are determined at least intermittently during operation of the EC motor.

7. The method according to claim 6, wherein the power is measured and the voltage is measured at the DC link capacitor to determine the DC link capacitance in order to determine the capacitance (C_{ZK}) of the DC link capacitor.

8. The method according to claim 1, wherein the determination of the DC link capacitance (C_{ZK}) is carried out by an observer system, wherein the observer system is only activated while the voltage ripple of the DC link voltage (U_{ZK}) is greater than the input voltage (U₀) of the voltage source, wherein a deactivation takes place thereafter, and wherein in particular the activation and/or deactivation are achieved by a multiplication by 0 or within a control algorithm by not carrying out a calculation of the observer.

9. The method according to claim 1, wherein a maximum value of the voltage ripple and/or a comparison between a detected voltage curve and a look-up table are used to infer a decrease in the DC link capacitance (C_{ZK}) or an increase in an internal loss resistance of the DC link capacitor.

10. The method according to claim 1, wherein a setpoint value for the d-current component (i_{d}) is calculated with a superposed PI controller, wherein a difference between the target DC link voltage and the measured DC link voltage is switched to an input of the controller, wherein a step-like excitation is added to the measured DC link voltage (U_{ZK}) as the target DC link voltage, and/or a constant value is used, whereby a curve of the d-current component (i_{d}) is formed by the controller.

11. The method according to claim 1, wherein a curve shape of the d-current component (i_{d}) is adapted by means of a neural network and/or artificial intelligence and/or as a function of the motor power and/or the speed during operation depending on the operating point.

12. The method according to claim 1, wherein a spectrum of a predetermined target current is adapted by means of pre-filtering in order to avoid noise generation of the motor windings, with parts of the spectrum and/or a required control reserve and/or a bandwidth being particularly reduced in a targeted manner.

13. The method according to claim 1, wherein a temperature prediction of a temperature of the inverter and/or a power module of the inverter, is determined, by way of a superposed neural network and/or a temperature model, in order to predict temperature jumps, wherein the temperature jumps predicted in this manner are at least partially compensated for by a regulation of the d-current component (i_{d}) by means of the controller, via an increase in the d-current component (i_{d}).

14. The method control circuit of an electrically commutated (EC) motor with motor windings for monitoring at least one DC link capacitor in an electrical DC link of the motor control circuit of the EC motor operated on a voltage source, according to a method of claim 1, comprising a rectifier and an inverter, wherein the at least one DC link capacitor to be monitored is located between the rectifier and the inverter, wherein a controller is provided for regulating a d-current component (i_{d}) of a DC link current, so that energy from the motor control circuit is stored in a magnetic field of the motor windings of the EC motor and/or the energy from the motor control circuit correspondingly stored in the magnetic field of the motor windings is discharged back into the motor control circuit, and wherein an evaluation circuit is provided for the purpose of determining a remaining service life or an end of service life and/or useful life of the DC link capacitor from a determined DC link capacitance (C_{ZK}).
